(19) United States
(12) Patent Application Publication
(10) Pub. No.: US 2013/0201149 A1
(43) Pub. Date: Aug. 8, 2013

(54) ELECTRONIC DEVICE WITH FEEDBACK FUNCTION

(71) Applicants: Woon-bo Yeo, Hwaseong-si (KR); Jong-ho Park, Yongin-si (KR)

(72) Inventors: Woon-bo Yeo, Hwaseong-si (KR); Jong-ho Park, Yongin-si (KR)

(73) Assignee: Samsung Electronics Co., Ltd., Suwon-si (KR)

(21) Appl. No.: 13/606,380

(22) Filed: Sep. 7, 2012

(30) Foreign Application Priority Data
Feb. 7, 2012 (KR) 10-2012-0012525

(51) Int. Cl. G06F 3/045

(52) U.S. Cl. 345/174

(57) ABSTRACT

An electronic device having a feedback function includes: a body; a button unit disposed in the body and includes a first sensing unit that senses an externally-applied touch operation to generate a first signal and a second sensing unit coupled to the first sensing unit and senses a variation in a physical quantity of the touch operation to generate a second signal that varies according to the variation in the physical quantity; a feedback generating unit disposed in the body and is operated by a feedback signal applied from the touch operation to generate feedback; and a controller that is electrically connected to the button unit to receive the first signal and the second signal and is electrically connected to the feedback generating unit to generate the feedback signal according to a variation in the feedback signal and changes a strength of the feedback generated by the feedback generating unit.

### CROSS-REFERENCE TO RELATED PATENT APPLICATION

This application claims the priority benefit of Korean Patent Application No. 10-2012-0012525, filed on Feb. 7, 2012, in the Korean Intellectual Property Office, the disclosure of which is incorporated herein in its entirety by reference.

### BACKGROUND

Various embodiments relate to an electronic device, and more particularly, to an electronic device that includes a plurality of sensing units and has a feedback function of generating feedback based on a contact operation.

Electronic devices, such as a camera, a mobile phone, or the like, include components, such as a switch, a button, or the like, for performing various functions. Since the switch or the button generates an on/off signal by a user's manipulation, operations of the electronic device may be controlled by using the generated on/off signal.

Japanese Laid-Open Patent Publication No. 2010-092071 discloses an electronic device including a switch that senses a user's touch and generates a signal. According to the electronic device, the electronic device may be controlled based on the user's touch sensed by the switch. However, the kinds of touch operations that may be sensed by the switch are limited, and the electronic device performs only a specific function that is previously determined based on a sensed touch operation.

### SUMMARY

Various embodiments provide an electronic device that may sense a user's touch operation by using various methods.

Various embodiments also provide an electronic device that may provide various types of feedback to a user of the electronic device based on a user's touch operation.

Various embodiments further provide an electronic device that may sense a user's touch with respect to the electronic device and provide feedback to the user based on the strength of the user's touch.

According to an embodiment, there is provided an electronic device including: a body; a button unit that is disposed in the body and includes a first sensing unit that senses an externally-applied touch operation to generate a first signal and a second sensing unit that is coupled to the first sensing unit and senses a variation in a physical quantity of the touch operation to generate a second signal that varies according to the variation in the physical quantity; a feedback generating unit that is disposed in the body and is operated by a feedback signal applied from the touch operation to generate feedback; and a controller that is electrically connected to the button unit to receive the first signal and the second signal and is electrically connected to the feedback generating unit to generate the feedback signal according to a variation in the second signal and thus changes a strength of the feedback generated by the feedback generating unit.

The first sensing unit may use at least one of a capacitance type sensing unit that senses a variation in a capacitance value due to a touch operation, a resistance film type sensing unit that may sense a variation in an electric resistance value at a touch portion, an optical sensing type sensing unit that senses a variation in a quantity of light to be received, a sound wave sensing type sensing unit that senses a variation in a sound wave to be received.

The physical quantity may include at least one of a pressing force applied by the touch operation and a time length in which the touch operation is performed.

The feedback generated by the feedback generating unit may be selected from the group consisting of vibration, sound, and light.

The second signal may be classified as two or more signals according to a magnitude of pressure.

The feedback generating unit may include a vibration generating unit that is operated by a signal applied from the controller to generate vibration.

The feedback generating unit may include a sound generating unit that is operated by a signal applied from the controller to generate sound.

The electronic device may further include a display unit that is operated by a signal applied from the controller to display an image, wherein the display unit adjusts at least one of a brightness and a color of an image to be displayed based on a magnitude of the second signal.

The feedback generating unit may include a lighting unit which emits light and is operated by a signal applied from the controller and adjusts an intensity of light.

The first sensing unit may sense the touch operation by using a signal selected from the group consisting of a capacitance signal, a resistance signal, a sound wave signal and a light signal.

According to another embodiment, there is provided an electronic device including: a body; a plurality of button units that are disposed in the body and each button unit includes a first sensing unit for sensing a touch operation to generate a first signal and a second sensing unit that is coupled to the first sensing unit and senses a magnitude of pressure of the touch operation to generate a second signal; a plurality of lighting units that are disposed in the body to respectively correspond to the plurality of button units and light the plurality of button units by a signal applied from the touch operation; and a controller that is electrically connected to the plurality of button units and the plurality of lighting units, receives the first signal and the second signal from the plurality of button units, and controls the plurality of lighting units.

If the first signal is generated in one of the plurality of button units, the controller may turn on one of the plurality of lighting units located corresponding to the button unit in which the first signal is generated.

The controller may adjust a quantity of light of the lighting unit based on a variation in the second signal.

If the first signal is generated in the button unit, the controller may set a quantity of light of at least one lighting unit located around the lighting unit corresponding to the button unit in which the first signal is generated, wherein the quantity of light of the at least one lighting unit is less than a quantity of light of the lighting unit corresponding to the button unit in which the first signal is generated.

The light generating unit may further include a color adjusting unit that changes a color of light, wherein the controller changes a color of light of at least one of the plurality of lighting units based on a variation in the second signal by controlling the color adjusting unit.

### BRIEF DESCRIPTION OF THE DRAWINGS

The above and other features and advantages will become more apparent by describing in detail exemplary embodiments thereof with reference to the attached drawings in which:

FIG. 1 is a perspective view of an electronic device having a feedback function, according to an embodiment;

FIG. 2 is a block diagram showing a schematic relationship between elements of the electronic device of FIG. 1;

FIG. 3 is a side cross-sectional view of a button unit of the electronic device of FIG. 1;

FIG. 4 is a flowchart for describing an operation method of the electronic device of FIG. 1;

FIG. 5 is a graph showing signals of the electronic device of FIG. 1;

FIG. 6 is a view for describing an operation of an electronic device, according to another embodiment;

FIG. 7 is a view for describing an operation of the electronic device of FIG. 6; and

FIG. 8 is a cross-sectional view taken along a line VIII-VIII of FIG. 7.

### DETAILED DESCRIPTION

Now, an exemplary embodiment of the invention will be described in detail with reference to the accompanying drawings.

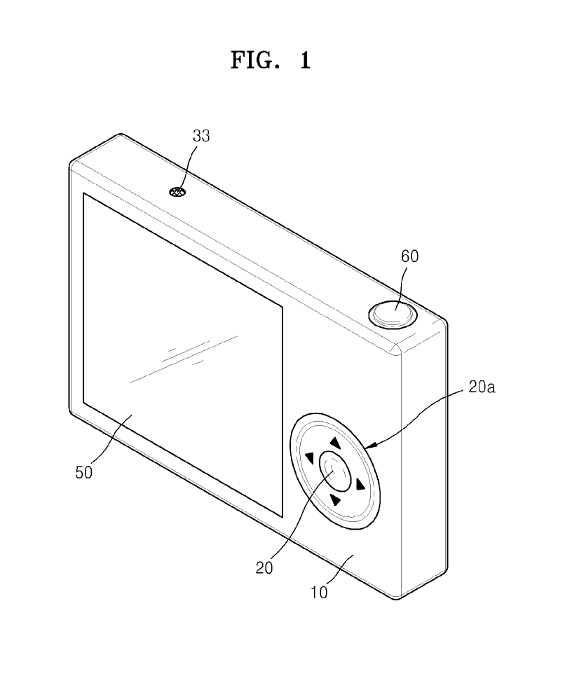

FIG. 1 is a perspective view of an electronic device having a feedback function, according to an embodiment.

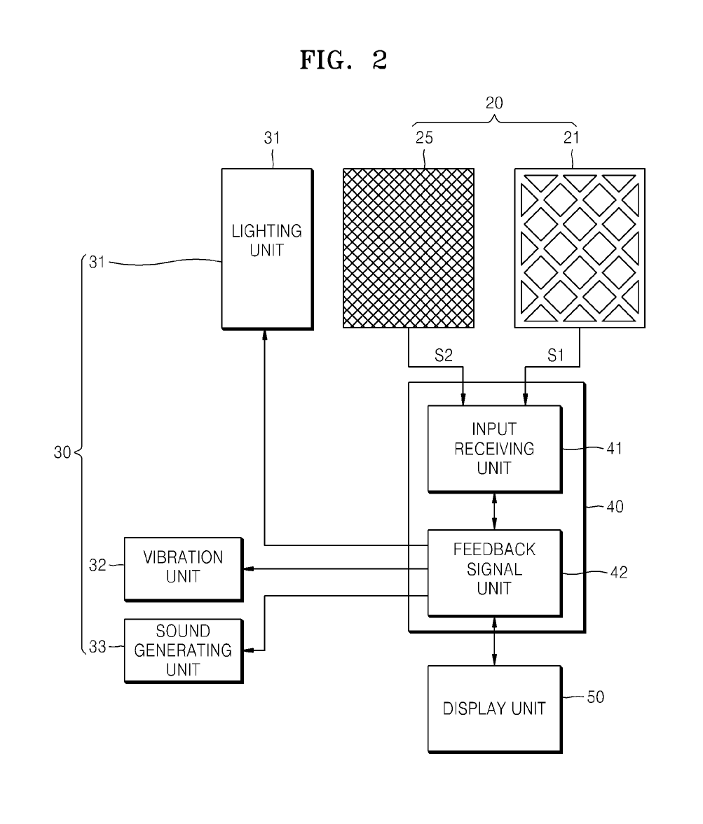

The electronic device having the feedback function includes a body 10, a button unit 20 disposed in the body 10, a feedback generating unit 30 (shown in FIG. 2) disposed in the body 10 and generating feedback, and a controller 40 (shown in FIG. 2) for controlling the feedback generating unit 30.

Although the electronic device of FIG. 1 is configured as a digital camera, the invention is not limited thereto. Accordingly, the electronic device may be configured as any of various portable electronic devices, such as a digital camera, a digital camcorder, a mobile phone, a smart phone, a multimedia player, a tablet computer, a desktop computer, a notebook computer, a car navigation device, and the like, or any of various types of devices such as a television and a desktop computer for the home or a machine equipment used in an industrial place.

The body 10 of the electronic device surrounds and supports various elements of the electronic device and may be formed of a metal material, such as aluminum, or the like, or a plastic material. A display unit 50 and a button assembly 20a are disposed on one surface of the body 10. Also, a sound generating unit 33 and a shutter button 60 are disposed at one edge of the body 10.

The button assembly 20a is operated by a user's manipulation and generates a signal for controlling the electronic device. The button unit 20 is disposed in the middle of the button assembly 20a. The button unit 20 generates a first signal by sensing a user's touch and generates a second signal by sensing strength of the user's touch.

The display unit 50 may be formed of a display device such as a liquid crystal display (LCD), an organic light-emitting diode (OLED) display, or the like. Also, a touch panel that senses a touch on a surface of the display unit 50 and generates a signal corresponding to a location of the sensed touch may be disposed on the surface of the display unit 50.

FIG. 2 is a block diagram showing a schematic relationship between elements of the electronic device of FIG. 1.

FIG. 2 shows elements disposed in the body 10 of the electronic device of FIG. 1. The controller 40 and the feedback generating unit 30 shown in FIG. 2 are disposed in the body 10 of FIG. 1.

The controller 40 is electrically connected to the button unit 20 and the feedback generating unit 30 and performs various functions. For example, the controller 40 exchanges a control signal between the button unit 20 and the feedback generating unit 30 and processes data.

The controller 40 includes an input receiving unit 41 and a feedback signal unit 42. The input receiving unit 41 receives a signal from a first sensing unit 21 and a second sensing unit 25 of the button unit 20. The feedback signal unit 42 controls the feedback generating unit 30 based on the signal applied to the input receiving unit 41. The feedback signal unit 42 may also control the display unit 50 based on the signal applied to the input receiving unit 41.

The controller 40 may be configured as a micro chip or a circuit board including a micro chip, and elements of the controller 40 may be configured by software or circuits installed in the controller 40.

The button unit 20 includes the first sensing unit 21 and the second sensing unit 25. The first sensing unit 21 generates a first signal S1 by sensing a touch applied from the outside by a user who manipulates a control device. The second sensing unit 25 generates a second signal S2 which varies according to a variation in a physical quantity by sensing the variation in the physical quantity of the user's touch.

The feedback generating unit 30 operates by a feedback signal applied from the controller 40 to generate feedback. The controller 40 may change a strength of the feedback generated by the feedback generating unit 30 by generating a feedback signal according to a variation in the second signal S2 generated by the second sensing unit 25.

The feedback generating unit 30 includes a lighting unit 31 for lighting the button unit 20, a vibration unit 32 for generating vibration, and the sound generating unit 33 for generating sound.

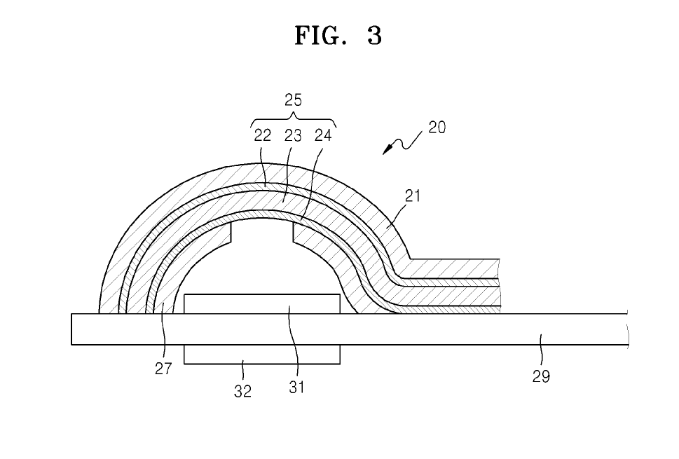

FIG. 3 is a side cross-sectional view of the button unit 20 of the electronic device of FIG. 1.

The button unit 20 includes the first sensing unit 21, which is electrically connected to a printed circuit board 29, and the second sensing unit 25. The first sensing unit 21 is disposed at an outermost side of the button unit 20, and contacts the body of a user who manipulates the electronic device.

The first sensing unit 21 may be configured as, for example, a capacitance type sensing unit that senses a variation in a capacitance value by using a touch operation, a resistance film type sensing unit that senses a variation in an electric resistance value at a touch portion, an optical sensing type sensing unit that senses a variation in a quantity of light received by using an optical sensor, a sound wave sensing type sensing unit that senses a variation in a sound wave received by using a sound wave sensor, or a combination of these types of sensing units.

The second sensing unit 25 generates a second signal by sensing a variation in a physical quantity of a user's touch. The physical quantity that may be sensed by a user may include at least one of a strength of a pressing force applied by the user's touch and a time when a touch operation is performed.

In FIG. 3, the second sensing unit 25 is formed by using a piezoelectric element 23. The second sensing unit 25 includes the piezoelectric element 23, a first electrode layer 22, and a second electrode layer 24, wherein the first electrode layer 22 and a second electrode layer 24 are coupled to both sides of the piezoelectric element 23 to apply electricity. The piezoelectric element 23 may be a multi-layered piezoelectric element manufactured by stacking a plurality of electrodes or a single-layered piezoelectric element. If alternating current (AC) is applied to the piezoelectric element 23, the piezoelectric element 23 generates vibrations according to a driving waveform of the applied current.

A hemispherical key 27 is disposed on the inner side of the second sensing unit 25. The hemispherical key 27 may be elastically deformed and contacts the second sensing unit 25 to elastically support the second sensing unit 25 and the first sensing unit 21. If pressure is applied from the outside by a user's touch, the hemispherical key 27 is compressed within a predetermined range, thereby providing a clicking feeling (a feeling that a position or a shape is changed due to a user's pressing operation) to a user.

If a user touches the first sensing unit 21 by using a body part such as a finger, the first sensing unit 21 generates a first signal and senses the user's touch. Also, the second sensing unit 25 may sense the strength of a pressing force applied to the button unit 20 by the user and may generate a second signal varying according to the applied force.

The lighting unit 31 is disposed between the hemispherical key 27 and the printed circuit board 29. The lighting unit 31 provides feedback due to lighting to a user by emitting light toward the button unit 20. The button unit 20 may include a transparent or semitransparent glass or a plastic material so as to transmit the light emitted from the lighting unit 31.

Also, the vibration unit 32 is disposed on the printed circuit board 29. The vibration unit 32 generates vibrations during the manipulation of the button unit 20 to provide feedback with the vibration to a user.

In the electronic device shown in FIGS. 1 to 3, the feedback generated by the feedback generating unit 30 may include vibration, sound, light, or a combination thereof. Also, strength of the feedback generated by the feedback generating unit 30 may vary according to a vibration in the second signal generated by the second sensing unit 25. Also, in addition to the feedback generated by the feedback generating unit 30, a quantity of light emitted when the display unit 50 shown in FIGS. 1 and 2 displays an image or a variation in color of the light may be provided as feedback to a user.

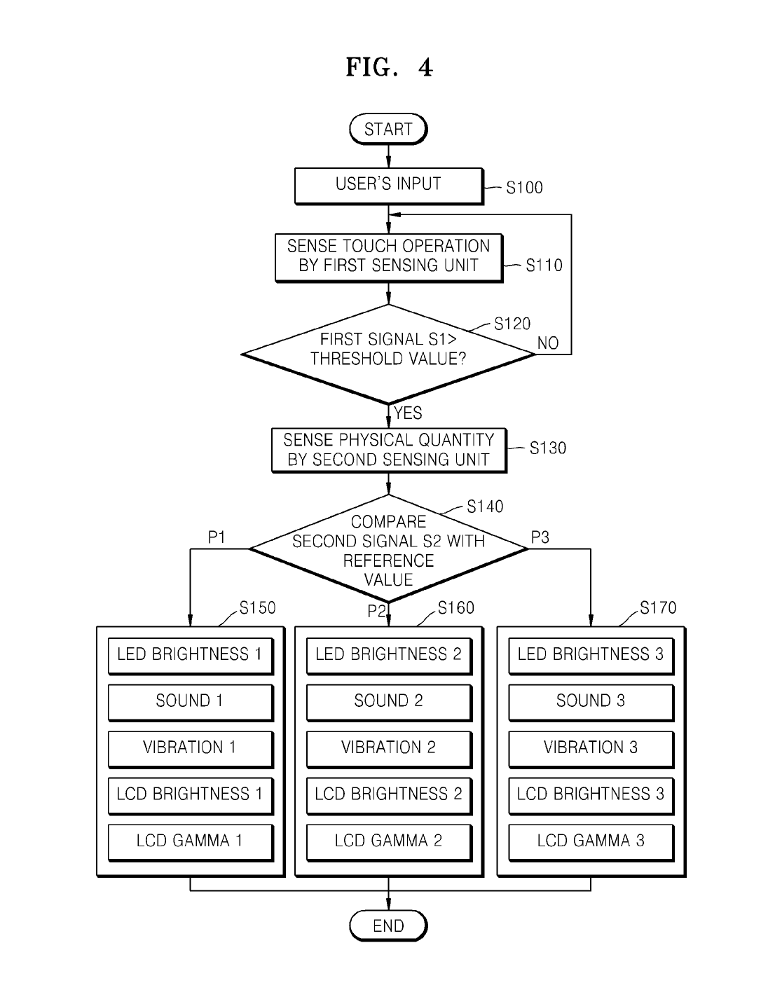

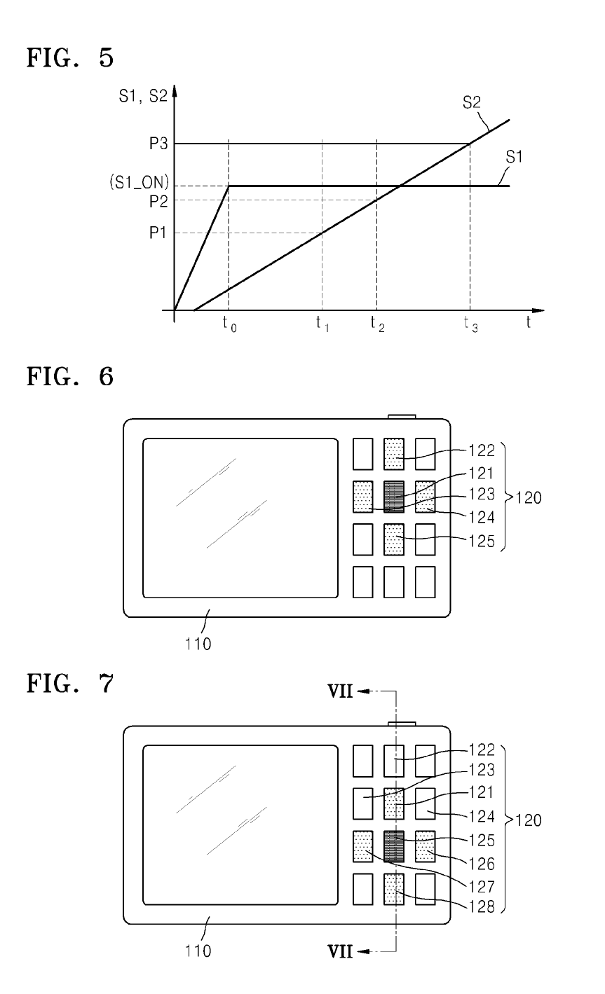

FIG. 4 is a flowchart for describing an operation method of the electronic device of FIG. 1. FIG. 5 is a graph showing signals of the electronic device of FIG. 1.

If there is a user's input to the button unit 20 of the electronic device of FIG. 1 through a touch operation (operation S100), the first sensing unit 21 senses the touch operation to generate a first signal 51 (operation S110). If the first signal is generated, the first signal 51 is compared with a threshold value (operation S120).

If the first signal 51 generated by the first sensing unit 21 is equal to or greater than a predetermined threshold value (S1_ON), it is determined that the user has touched or manipulated the button unit 20, and thus the second sensing unit 25 senses a physical quantity of the user's touch (operation S130). If the first signal S1 is less than the predetermined threshold value (S1_ON), the operation returns to operation S110 in which the first sensing unit 21 senses the touch operation. Referring to FIG. 5, the first signal S1 generated by the first sensing unit 21 reaches the threshold value (S1_ON) at a time t0, and thus, it may be determined that a user's touch has occurred.

The threshold value (S1_ON), which is a standard for determining the first signal 51 of the first sensing unit 21, is a value for determining whether a user actually touches the button unit 20. For example, when the first sensing unit uses a capacitance type sensing unit, the threshold value (S1_ON) may be a capacitance value, and when the first sensing unit uses a resistance film type sensing unit, the threshold value (S1_ON) may be an electric resistance value.

In operation S130 in which the second sensing unit 25 senses a physical quantity, a variation in the physical quantity of a user's touch is sensed to generate the second signal S2 which varies according to a variation in the physical quantity. Also, the second signal S2 is compared with a reference value (operation S140).

Referring to FIG. 5, a reference value which is a standard for comparison with the second signal S2 is classified as values P1, P2, and P3. If the physical quantity is a pressing force, the reference value may be determined according to a strength of the pressing force by using a method of previously defining sections where the second signal S2 varies. Accordingly, P1 corresponds to a signal when the touch operation is performed with a lowest strength, P2 corresponds to a signal when the touch operation is performed with a medium strength, and P3 corresponds to a signal when the touch operation is performed with a greatest strength.

However, the invention is not limited to the number of reference values which are standards for comparison with the second signal S2 or to the method of determining the reference value, and thus, the reference values may be set as P1 and P2 or may be previously determined as four or more values.

FIG. 5 is a graph showing when magnitudes of the second signal S2 reach reference values P1, P2, and P3 at times t1, t2, and t3, respectively, as the magnitudes of the second signal S2 vary according to a magnitude of a pressing force.

Referring to FIG. 4, when the second signal S2 corresponds to a value equal to or more than the reference value P1 corresponding to a lowest pressing force, feedback of a first strength is provided (operation S150). When the second signal S2 corresponds to a value equal to or more than the reference value P2 corresponding to a medium pressing force, feedback of a second strength is provided (operation S160). When the second signal S2 corresponds to a value equal to or more than the reference value P3 corresponding to a greatest pressing force, feedback of a third strength is provided (operation S170).

In operations S150 to S170, a quantity of light may be changed by adjusting a brightness of a light-emitting diode (LED) of the lighting unit 31 of the feedback generating unit 30 shown in FIG. 2 from 1 to 3 stages, a sound level of the sound generating unit 33 may be adjusted from 1 to 3 stages, a vibration magnitude of the vibration unit 32 may be adjusted from 1 to 3 stages, a brightness of a liquid crystal display (LCD) of the display unit 50 may be adjusted from 1 to 3 stages, or an LCD gamma, which is a color of the display unit 50, may be adjusted from 1 to 3 stages.

In the flowchart shown in FIG. 4, it has been described that when the first signal S1 of the first sensing unit 21 is equal to or greater than the threshold value (S1_ON), operations S150 to S170 for providing feedback based on the second signal S2 of the second sensing unit 25 are performed. However, the invention is not limited thereto. Alternatively, when the first signal S1 generated by the first sensing unit 21 is equal to or greater than the threshold value (S1_ON), it may be determined that a user's touch has occurred, and then feedback may be immediately provided. For example, as soon as a user's touch is sensed by the first sensing unit 21, the lighting unit 31 may be operated or the vibration unit 32 may be operated.

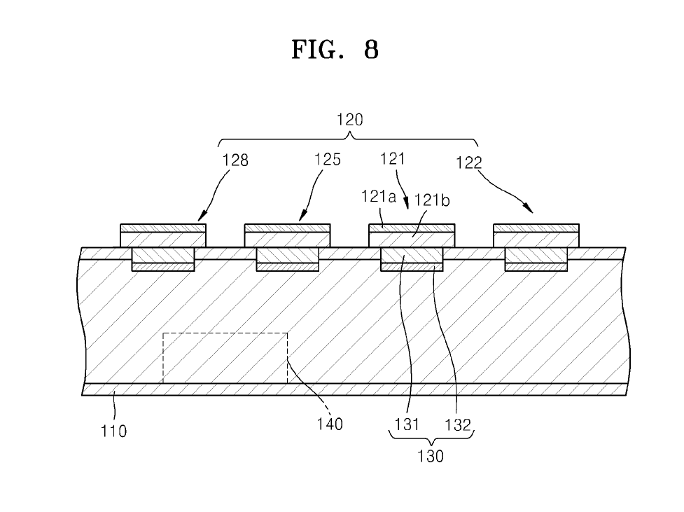

FIG. 6 is a view for describing an operation of an electronic device, according to another embodiment. FIG. 7 is a view for describing an operation of the electronic device of FIG. 6. FIG. 8 is a cross-sectional view taken along a line VIII-VIII of FIG. 7.

The electronic device shown in FIGS. 6 and 7 includes a body 110, a button array 120 including a plurality of button units 121 to 128 disposed in the body 110, a plurality of lighting units 131 (shown in FIG. 8) that are disposed in the body 110 to respectively correspond the button units 121 to 128 and light the button units 121 to 128 by a signal applied from the outside, and a controller 140 (shown in FIG. 8) that is electrically connected to the button units 121 to 128 and the lighting units 131 to control the lighting units 131.

The button units 121 to 128 are disposed in the body 110 by forming an array. Referring to FIG. 8, the button units 121 to 128 have the same structure, and each of the button units 121 to 128 includes a first sensing unit 121a for generating a first signal by sensing a user's touch and a second sensing unit 121b for generating a second signal by sensing strength of pressure to be applied.

A feedback generating unit 130 may include the lighting unit 131 and a vibration unit 132. The lighting unit 131 may be disposed under each of the button units 121 to 128, and emits light toward each of the button units 121 to 128. The button units 121 to 128 may include a transparent or semitransparent glass so as to transmit light. The lighting unit 131 may be operated by a signal applied from the controller 140 to change a quantity of light and may change a color of light to be emitted. In order to change the color of light to be emitted, various methods may be used. For example, a plurality of different colors of light sources may be disposed to control operations of the light sources, or a color filter operating by an electric signal may be used.

Also, a vibration unit 132 may be disposed below each of the button units 121 to 128. The vibration unit 132 generates vibrations when a user's touch is performed on each of the button units 121 to 128 and provides feedback with the vibration to a user.

If the first sensing unit 121a generates a first signal because a user touches the button units 121 to 128, the controller 140 turns on or off the lighting units 131 located corresponding to the button units 121 to 128 in which the first signal is generated.

FIG. 6 is a view showing when a user touches the button unit 121 from among the button units 121 to 128. The lighting unit 131 corresponding to the button unit 121 touched by the user is turned on with the greatest quantity of light, and thus, brightness of the lighting unit 131 is highest. The lighting units 131 corresponding to the button units 122 to 125 located around the button unit 123 are turned on with a low quantity of light.

If the user touches the button unit 125 from among the button units 121 to 128, as shown in FIG. 7, the button unit 125 touched by the user is turned on with the greatest quantity of light and the button units 121 to 128 located around the button unit 125 are turned on with a low quantity of light.

As such, since light having a quantity adjusted by the lighting unit 131 is provided as feedback to the user, the user may conveniently recognize contact states of the button unit 121 touched by the user and the button units 122 to 125 located around the button unit 121. Also, a manipulation error that may occur due to confusion over which one of the button units 121 to 128 is touched may be minimized.

Also, the second sensing unit 121b generates a second signal according to a magnitude of a pressing force applied to the button units 121 to 128. The controller 140 may adjust a quantity of light of the lighting unit 131 based on a magnitude of the second signal. In other words, the stronger the pressing force is, the more the quantities of light of the lighting units 131 corresponding to the button units 121 to 128 are.

The invention is not limited to feedback varying based on the magnitude of the second signal, and various other methods may be used. For example, the controller 140 may change a color of light emitted by the lighting unit 131 based on the magnitude of the second signal.

The electronic device described herein may comprise a processor, a memory for storing program data and executing it, a permanent storage such as a disk drive, a communications port for handling communications with external devices, and user interface devices, such as a touch panel, keys, buttons, etc. When software modules or algorithms are involved, these software modules may be stored as program instructions or computer-readable codes executable by the processor on a non-transitory computer-readable recording medium. Examples of the computer-readable recording medium are magnetic storage media (e.g., ROM, floppy disks, and hard disks), optical recording media (e.g., CD-ROMs and DVDs), etc. The computer-readable recording medium can also be distributed over network-coupled computer systems so that the computer-readable code is stored and executed in a distributed fashion. These media can be read by a computer, stored in the memory, and executed by the processor.

Also, using the disclosure herein, programmers of ordinary skill in the art to which the invention pertains may easily implement functional programs, codes, and code segments for making and using the invention.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to exemplary embodiments illustrated in the drawings, and specific terminology has been used to describe these embodiments. However, no limitation of the scope of the invention is intended by this specific terminology, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements the invention may be implemented with any programming or scripting language such as C, C++, Java, assembly language, or the like, with the various algorithms being implemented with any combination of data structures, objects, processes, routines or other programming elements. Functional aspects may be implemented in algorithms that execute on one or more processors. Furthermore, the invention could employ any number of conventional techniques for electronics configuration, signal processing and/or control, data processing and the like. The words “mechanism”, “element”, “means”, and “configuration” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical connections between the various elements. It should be noted that many alternative or additional functional relationships, physical connections or logical connections may be present in a practical device. Moreover, no item or component is essential to the practice of the invention unless the element is specifically described as “essential” or “critical”.

It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The invention is not limited to the described order of the steps. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

What is claimed is:

1. An electronic device comprising:
a body;
a button unit that is disposed in the body and comprises a first sensing unit that senses an externally-applied touch operation to generate a first signal and a second sensing unit that is coupled to the first sensing unit and senses a variation in a physical quantity of the touch operation to generate a second signal that varies according to the variation in the physical quantity;
a feedback generating unit that is disposed in the body and is operated by a feedback signal applied from the touch operation to generate feedback; and
a controller that is electrically connected to the button unit to receive the first signal and the second signal and is electrically connected to the feedback generating unit to generate the feedback signal according to a variation in the second signal and thus changes a strength of the feedback generated by the feedback generating unit.

2. The electronic device of claim 1, wherein the first sensing unit uses at least one of a capacitance type sensing unit that senses a variation in a capacitance value due to a touch operation, a resistance film type sensing unit that senses a variation in an electric resistance value at a touch portion, an optical sensing type sensing unit that senses a variation in a quantity of light to be received, and a sound wave sensing type sensing unit that senses a variation in a sound wave to be received.

3. The electronic device of claim 1, wherein the physical quantity comprises at least one of a pressing force applied by the touch operation and a time length in which the touch operation is performed.

4. The electronic device of claim 1, wherein the feedback generated by the feedback generating unit is selected from the group consisting of vibration, sound, and light.

5. The electronic device of claim 1, wherein the second signal is classified as two or more signals according to a magnitude of pressure.

6. The electronic device of claim 1, wherein the feedback generating unit comprises a vibration generating unit that is operated by a signal applied from the controller to generate vibration.

7. The electronic device of claim 1, wherein the feedback generating unit comprises a sound generating unit that is operated by a signal applied from the controller to generate sound.

8. The electronic device of claim 1, further comprising a display unit that is operated by a signal applied from the controller to display an image, wherein the display unit adjusts at least one of a brightness and a color of an image to be displayed based on a magnitude of the second signal.

9. The electronic device of claim 1, wherein the feedback generating unit comprises a lighting unit which emits light and is operated by a signal applied from the controller and adjusts an intensity of light.

10. The electronic device of claim 1, wherein the first sensing unit senses the touch operation by using a signal selected from the group consisting of a capacitance signal, a resistance signal, a sound wave signal, and a light signal.

11. An electronic device comprising:
a body;
a plurality of button units that are disposed in the body and each button unit comprises a first sensing unit that senses a touch operation to generate a first signal and a second sensing unit that is coupled to the first sensing unit and senses a magnitude of pressure of the touch operation to generate a second signal;
a plurality of lighting units that are disposed in the body to respectively correspond to the plurality of button units and light the plurality of button units by a signal applied from the touch operation; and
a controller that is electrically connected to the plurality of button units and the plurality of lighting units, receives the first signal and the second signal from the plurality of button units, and controls the plurality of lighting units.

12. The electronic device of claim 11, wherein when the first signal is generated by one of the plurality of button units, the controller turns on one of the plurality of lighting units located corresponding to the button unit in which the first signal is generated.

13. The electronic device of claim 12, wherein the controller adjusts a quantity of light of the lighting unit based on a variation in the second signal.

14. The electronic device of claim 12, wherein when the first signal is generated in the button unit, the controller sets a quantity of light of at least one lighting unit located around the lighting unit located corresponding to the button unit in which the first signal is generated, wherein the quantity of light of the at least one lighting unit is less than a quantity of light of the lighting unit corresponding to the button unit in which the first signal is generated.

15. The electronic device of claim 11, wherein the light generating unit further comprises a color adjusting unit that changes a color of light, wherein the controller changes a color of light of at least one of the plurality of lighting units based on a variation in the second signal by controlling the color adjusting unit.
